(19) United States
(12) Patent Application Publication
(10) Pub. No.: US 2005/0185336 A1
(43) Pub. Date: Aug. 25, 2005

(54) [FILM REMOVING EQUIPMENT, ERASING DEVICE AND METHOD OF FABRICATING ORGANIC ELECTRO-LUMINESCENT DEVICE]

(76) Inventors: Chun-Chien Chen, Hsinchu County (TW); Chi-Kuei Liao, Kaohsiung County (TW); Chih-Chiang Huang, Taoyuan County (TW); Lai-Cheng Chen, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,466

(22) Filed: May 7, 2004

(30) Foreign Application Priority Data
Feb. 24, 2004 (TW) 93104549

(51) Int. Cl. G11B 5/03

(52) U.S. Cl. 360/126

(57) ABSTRACT

A film removing equipment for removing a film from a substrate is provided. The film removing equipment comprises a base, a transmission mechanism of the erasing device, an erasing device and a positioning platform. The transmission mechanism of the erasing device is set up on the base and the erasing device is set up on the transmission mechanism. The positioning platform is set up on the base to carry the substrate. The transmission mechanism drives the erasing device to remove the film from the substrate. Using the aforementioned film removing equipment, the cost of removing a film from a substrate is reduced substantially.

### CROSS REFERENCE TO RELATED APPLICATIONS

This application claims the priority benefit of Taiwan application serial no. 93104549, filed Feb. 24, 2004.

### BACKGROUND OF INVENTION

1. Field of the Invention

The present invention relates to a film removing equipment and a method of fabricating a light emitting device. More particularly, the present invention relates to a film removing equipment, an erasing device and a method of fabricating an organic light emitting device (OLED).

2. Description of the Related Art

Organic electro-luminescent devices (OELD) are a kind of self-emitting displays fabricated using an organic functional material. According to the molecular weight of the organic functional material, organic electro-luminescent devices can be divided into a small molecule OELD (SM-OELD) and a polymer light emitting device (PLED). Both types of light emitting devices are constructed by sandwiching an organic functional material layer between a pair of electrodes. When a D.C. bias is applied between the electrodes, holes are injected from the anode into the organic material layer while electrons are injected from the cathode into the organic material layer. Due to the potential created by an external bias, the holes and electrons migrating into the organic functional layer will recombine. Some of the energy released in hole/electron recombination excites some of the molecules within the organic functional layer to a singly excited state. When a singly excited molecule returns to the ground state, a certain portion of the energy is released as photons in the visible frequency range. This is the principle behind the generation of light in an organic electro-luminescent device.

To produce organic electro-luminescent devices en-mass, a relatively large piece of uncut substrate is selected. The substrate is partitioned into a plurality of block areas and then an organic electro-luminescent device is fabricated in each block area. Thereafter, the organic electro-luminescent devices on the substrate are cut out in a singulation process. In the following, a detailed description of the steps for fabricating an conventional organic electro-luminescent device is provided.

FIGS. 1A through 1D are schematic cross-sectional views showing the steps for producing a conventional organic electro-luminescent device. As shown in FIG. 1A, a substrate 100 is provided. Thereafter, an anode layer 120 is formed over the substrate 100. A spin-on coating process is performed to form an organic material layer 130 over the anode layer 120.

As shown in FIG. 1B, the organic material layer 130 is patterned to form a light-emitting region 100a. As shown in FIG. 1C, a cathode layer 140 is formed over the organic material layer 130. As shown in FIG. 1D, a molding process is performed so that a portion of the anode layer 120, the organic material layer 130 and a portion of the cathode layer 140 can be encapsulated by a molding compound 150. Finally, the substrate 110 is cut to produce a plurality of single organic electro-luminescent devices 100.

In the aforementioned process, the organic material layer 130 is patterned by performing a laser ablation process or a dry etching process. In a laser ablation process, patterning is carried out through aiming a laser beam with an appropriate wavelength at the organic material layer 130. The laser beam burns away a portion of the organic material layer 130 on the substrate 110 directly or initiates a photoreaction to remove the organic material. Although laser ablation is an effective method of removing the organic material layer 130, cost of the equipment is high. Moreover, a laser beam has a narrow irradiation area so that it is difficult for a laser beam to remove all the unwanted organic material from an organic material layer in a single operation. In addition, a portion of the laser-irradiated organic material layer 130 may contain contaminants.

The dry etching process is performed using plasma and reactive gas in a vacuum environment. A mask is set up over the substrate 110 so that only the organic material exposed thereby is etched. Compared with the laser ablation process, the dry etching removes organic material faster and has a higher throughput. Yet, dry etching demands the production of a complicated mask and the purchase of expensive vacuum equipment. Furthermore, organic materials unsuitable for plasma processing cannot be etched using the plasma method. In general, both the laser ablation process and the dry etching process are constrained by the particular type of organic material to be removed.

### SUMMARY OF INVENTION

Accordingly, at least one objective of the present invention is to provide a film removing equipment capable of removing the film in a non-vacuum environment.

At least a second objective of the present invention is to provide an erasing device capable of removing various types of organic material films.

At least a third objective of the present invention is to provide a method of fabricating an organic electro-luminescent device for removing various types of organic films.

To achieve these and other advantages and in accordance with the purpose of the invention, as embodied and broadly described herein, the invention provides a film removing equipment for removing a film from a substrate. The film removing equipment comprises a base, a transmission mechanism of the erasing device, a first erasing device, and a positioning platform. The transmission mechanism of the erasing device is set up on the base and the first erasing device is set up on the transmission mechanism. The positioning platform is set up on the base to carry the substrate. The transmission mechanism drives the erasing device to remove the film from the substrate.

According to the film removing equipment of the present invention, the first erasing device comprises a tape supply module, a tape collect module and an erasing head module. The erasing head module is set up between the tape supply module and the tape collect module. The tape supply module provides an erasing tape to the erasing head module and the tape collect module receives the used tape from the erasing head module.

According to the film removing equipment of the present invention, the tape supply module further comprises a tape supply mechanism and a first set of idle wheels. The tape supply mechanism provides an erasing tape and the first set of idle wheels is set up between the erasing head module and the tape supply mechanism. In addition, the tape collect module further comprises a tape collect mechanism and a second set of idle wheels. The tape collect mechanism receives the erasing tape. The second set of idle wheels is set up between the erasing head module and the tape collect mechanism.

According to the film removing equipment of the present invention, the first erasing device further comprises an erasing head transmission mechanism. The erasing head module is set up on the erasing head transmission mechanism.

According to the film removing equipment of the present invention, the first erasing device further comprises an erasing liquid supply module connected to the erasing head module for providing an erasing liquid to the erasing head module. In addition, the erasing head module has an erasing liquid supply pass. The erasing liquid supply module is connected to the erasing liquid supply pass for supplying erasing liquid to the erasing tape.

According to the film removing equipment of the present invention, the first erasing device further comprises at least an optical sensor set up along the transmission pathway of the erasing tape.

According to the film removing equipment of the present invention, the erasing tape is fabricated using dust-proofing cloths.

According to the film removing equipment of the present invention, the positioning platform comprises a positioning mechanism for positioning the substrate on the platform.

According to the film removing equipment of the present invention, the equipment further comprises a positioning platform transmission mechanism connected to the positioning platform for controlling the movement of the positioning platform.

According to the film removing equipment of the present invention, the equipment further comprises a second erasing device set up on the transmission mechanism of the erasing device.

The present invention also provides an erasing device. The erasing device comprises a tape supply module, a tape collect module and an erasing head module. The erasing head module is set up between the tape supply module and the tape collect module. The tape supply module provides an erasing tape to the erasing head module and the tape collect module receives the used erasing tape from the erasing head module.

According to the erasing device of the present invention, the tape supply module further comprises a tape supply mechanism and a first set of idle wheels. The tape supply mechanism provides an erasing tape and the first set of idle wheels is set up between the erasing head module and the tape supply mechanism. In addition, the tape collect module further comprises a tape collect mechanism and a second set of idle wheels. The tape collect mechanism receives the erasing tape. The second set of idle wheels is set up between the erasing head module and the tape collect mechanism.

According to the erasing device of the present invention, the erasing device further comprises an erasing head transmission mechanism. The erasing head module is set up on the erasing head transmission mechanism.

According to the erasing device of the present invention, the erasing device further comprises an erasing liquid supply module connected to the erasing head module for providing an erasing liquid to the erasing head module. In addition, the erasing head module has an erasing liquid supply pass. The erasing liquid supply module is connected to the erasing liquid supply pass for supplying erasing liquid to the erasing tape.

According to the film removing equipment of the present invention, the erasing device further comprises at least an optical sensor set up along the transmission pathway of the erasing tape.

According to the film removing equipment of the present invention, the erasing tape is fabricated using dust-proofing cloths, for example.

The present invention also provides a method of fabricating an electro-luminescent device. First, a substrate is provided. A first electrode layer is formed over the substrate. Thereafter, an organic material layer is formed over the first electrode layer and a portion of the substrate. A portion of the organic material layer is removed by performing an erasing process using an erasing liquid so that a patterned organic material layer is formed. Finally, a second electrode layer is formed over the patterned organic material layer.

According to the method of fabricating the organic electro-luminescent device of the present invention, the method further comprises encapsulating a portion of the first electrode layer, the organic material layer and a portion of the second electrode layer using a molding compound to form a plurality of organic electro-luminescent devices.

According to the method of fabricating the organic electro-luminescent device of the present invention, the method further comprises cutting up the substrate to form a plurality of organic electro-luminescent device.

In brief, the film removing equipment of the present invention uses an erasing method to remove films from a substrate. Hence, the film removing equipment can be used to remove various types of materials, in particular, the type of materials that cannot be removed by a laser ablation process or a dry etching process. Furthermore, unlike the laser ablation process and the dry etching process, which demands either a high vacuum or a special gaseous environment, the film can be removed from the substrate with no particular environmental preconditions.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A through 1D are schematic cross-sectional views showing the steps for producing a conventional organic electro-luminescent device.

FIG. 2A is a front view of a film removing equipment according to one preferred embodiment of the present invention.

FIG. 2B is a top view of a film removing equipment according to one preferred embodiment of the present invention.

FIG. 3 shows a front view and a side view of an erasing device according to one preferred embodiment of the present invention.

FIGS. 4A through 4E are perspective views showing the steps for fabricating an organic electro-luminescent device according to one preferred embodiment of the present invention.

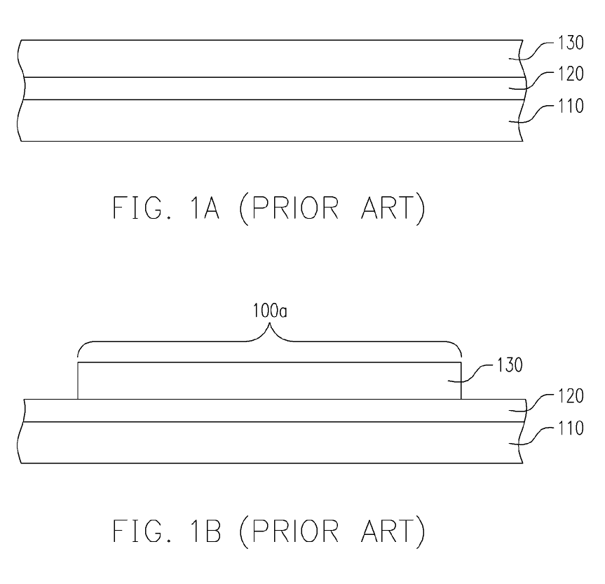

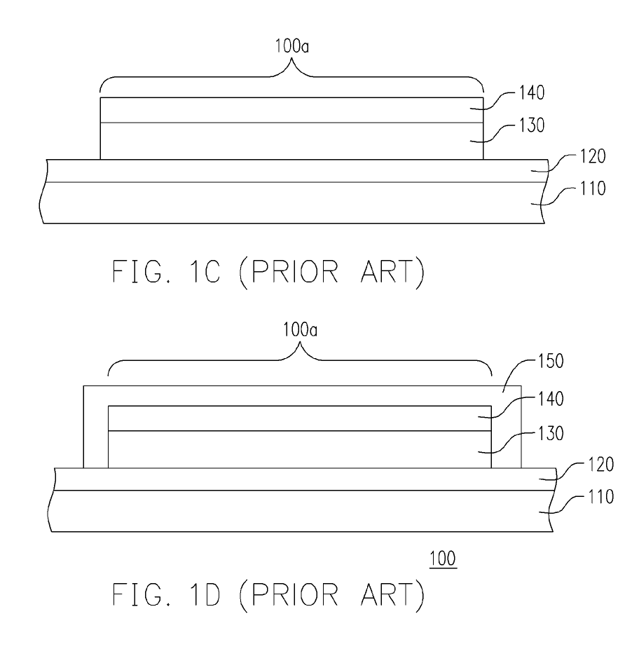

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

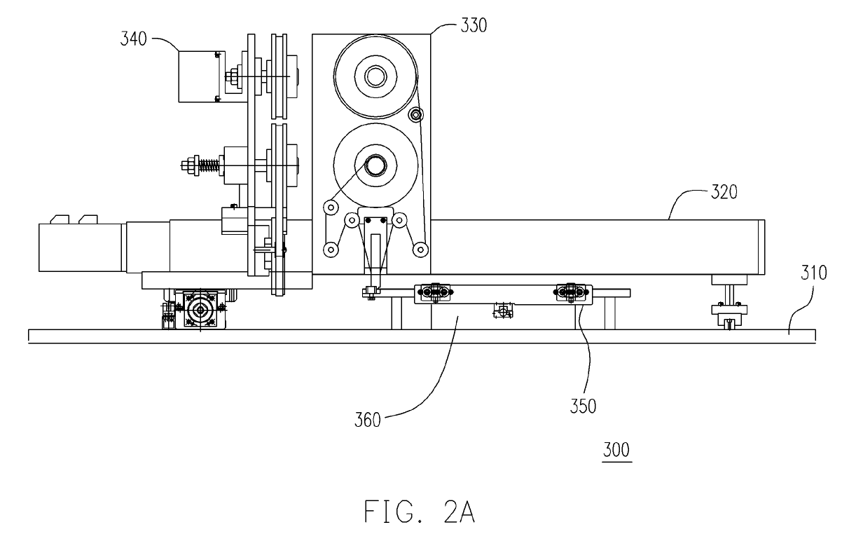

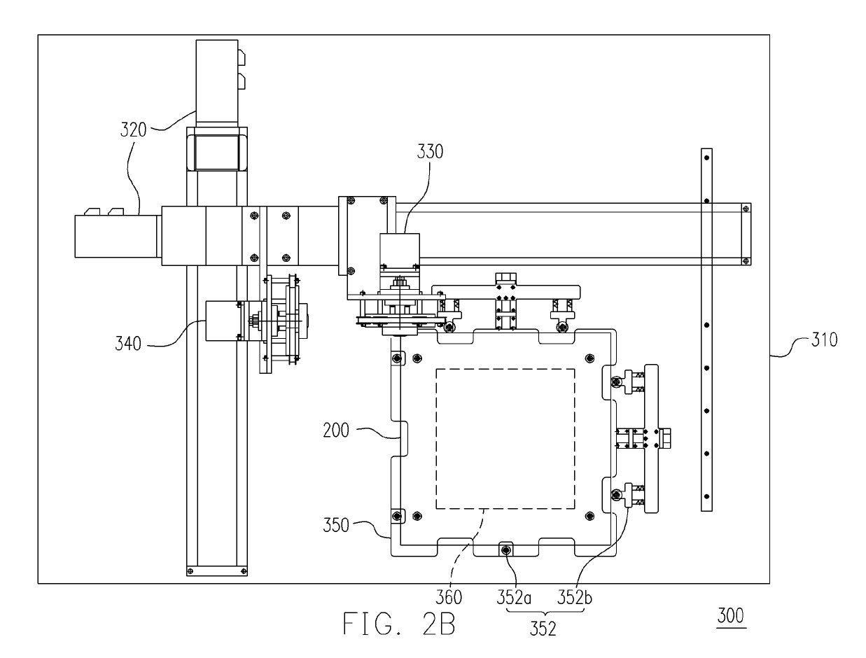

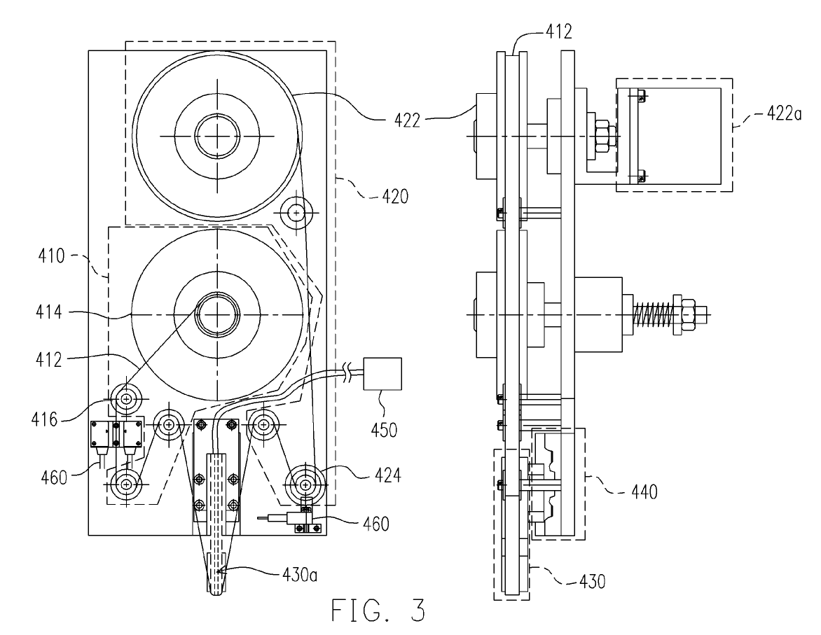

FIG. 2A is a front view of a film removing equipment according to one preferred embodiment of the present invention. FIG. 2B is a top view of a film removing equipment according to one preferred embodiment of the present invention. A film removing equipment 300 suitable for removing a film from a substrate 200 is shown in FIGS. 2A and 2B. The film removing equipment 300 comprises a base 310, a erasing device transmission mechanism 320, a first erasing device 330, a second erasing device 340 and a positioning platform 350. The transmission mechanism 320 of the erasing device is set up on the base 310. The first erasing device 330 and the second erasing device 340 are set up on the transmission mechanism 320. In addition, the positioning platform 350 is set up on the base 310 to support the substrate (as shown in FIG. 2B). The transmission mechanism 320 drives the first erasing device 330 and the second erasing device 340 to remove films from the substrate 200.

As shown in FIG. 2B, the transmission mechanism 320 of the erasing device further comprises an XY axis transmission structure, for example. The second erasing device 340 is set up in a direction perpendicular to the first erasing device 330. However, the present invention also permits the second erasing device 340 set at any angle relative to the first erasing device 330. Furthermore, the positioning platform 350 may comprise a positioning mechanism 352 for positioning the substrate 200 over the positioning platform 350. The positioning mechanism 352 includes a plurality of position pins 352a and a plurality of push pads 352b, for example. The substrate 200 leans against the position pins 352a and the push pads 352b. It should be noted that the transmission mechanism 320 of the erasing device is not limited to an XY axis transmission structure. The transmission mechanism 320 is mainly an apparatus for driving the first erasing device 330 or the second erasing device 340 to any location on the substrate 200. Hence, a robotic arm or any apparatus capable of such transmission function is within the scope of the present invention. In addition, the positioning mechanism 352 is not limited to a combination of position pins 352a and push pads 352b. In fact, the positioning mechanism 352 can be a backing structure, a clamper or any structure capable of fastening the substrate 200.

Through the position pins 352a and the push pads 352b, a rough adjustment of the positioning platform 350 is obtained. For finer adjustment, the film removing equipment 300 may include a positioning platform transmission mechanism 360 connected to the positioning platform 350 for controlling the movement of the positioning platform. 350. In addition, the positioning platform transmission mechanism 360 may incorporate an image adjustment system having a charge-coupled device (CCD) to attain a higher precision. It should be noted that the first erasing device 330 or the second erasing device 340 can be independently moved to any location inside the substrate if the positioning platform transmission mechanism 360 and the transmission mechanism 320 of the erasing device are used together.

As shown in FIG. 2B, the film removing equipment 300 uses either the first erasing device 330 or the second erasing device 340 to remove the film on the substrate 200 through wiping. Hence, the film removing equipment 300 of the present invention can be used to remove various types of film materials, in particular, those film materials that cannot be removed through a laser ablation process or a dry etching process. Unlike the laser ablation or dry etching method of removing the film from the substrate, which demands a high vacuum or special gaseous environment, the film removing equipment 300 can operate in a non-vacuum environment. Thus, the film removing equipment 300 of the present invention has a lower setup and maintenance cost. Furthermore, the film removing equipment 300 can be switched over to the fabrication of a new product simply by reprogramming the movement of the first erasing device 330 or the second erasing device 340. Unlike the dry etching process, there is no need to produce expensive mask. Moreover, the film removing equipment 300 can be used to process a substrate with a distribution of sizes when the transmission mechanism 320 of the erasing device and the positioning platform 350 are properly synchronized.

FIG. 3 shows a front view and a side view of an erasing device according to one preferred embodiment of the present invention. The erasing device 400 comprises a tape supply module 410, a tape collect module 420 and an erasing head module 430. The erasing head module 430 is set up between the tape supply module 410 and the tape collect module 420. The tape supply module 410 provides an erasing tape 412 to the erasing head module 430 and the tape collect module 420 receives used tape from the erasing head module 430. To facilitate operation, the erasing device 400 may include an erasing head transmission mechanism 440 for mounting the erasing head module 430. Furthermore, the erasing tape 412 can be dust-proofing cloths or fabricated from a dust-proofing material, for example. The erasing tape 412 has a width between about 5 to 10 mm, preferably 8 mm. The tape supply module 410, the tape collect module 420, the erasing head module 430 are further described below.

As shown in FIG. 3, the tape supply module 410 comprises a tape supply mechanism 414 and a first set of idle wheels 416. The tape supply mechanism 414 provides the erasing tape 412. The first set of idle wheels 416 is set up between the erasing head module 430 and the tape supply mechanism 414. The tape collect module 420 comprises a tape collect mechanism 422 and a second set of idle wheels 424. The tape collect mechanism 422 collects the erasing tape 412. The tape collect mechanism 422 further comprises a driving motor 422a. The second set of idle wheels 424 is set up between the erasing head module 430 and the tape collect mechanism 422.

If the erasing tape 412 requires some erasing liquid capable of dissolving the film material to perform the erasing operation, the erasing device 400 will include an erasing liquid supply module 450 connected to the erasing head module 430. The erasing liquid supply module 450 further comprises an erasing liquid pump (not shown) for controlling the supply of the erasing liquid. In addition, an optical sensor 460 is also installed on the erasing device 400 somewhere along the transmission pathway of the erasing tape 412 so that any break in the erasing tape 412 is immediately detected. In general, the optical sensor 460 comprises a laser sensor, an infrared sensor or other optical sensor, for example.

In the aforementioned erasing device 400, a film layer on a substrate is removed by the abrasive action of running the erasing liquid soaked erasing tape 412 over the film layer. Since the erasing tape 412 carries away any dissolved film material immediately, no residual material is retained to contaminate the substrate. Furthermore, using the tape supply module 410, tape collect module 420 and the erasing tape 412 assembly, the erasing device 400 can operate continuously to remove film material from the substrate 200 until all clean erasing tape 412 have been used. In other words, there is no need to stop the erasing device 400 for a long period of time after loading a new reel of erasing tape 412.

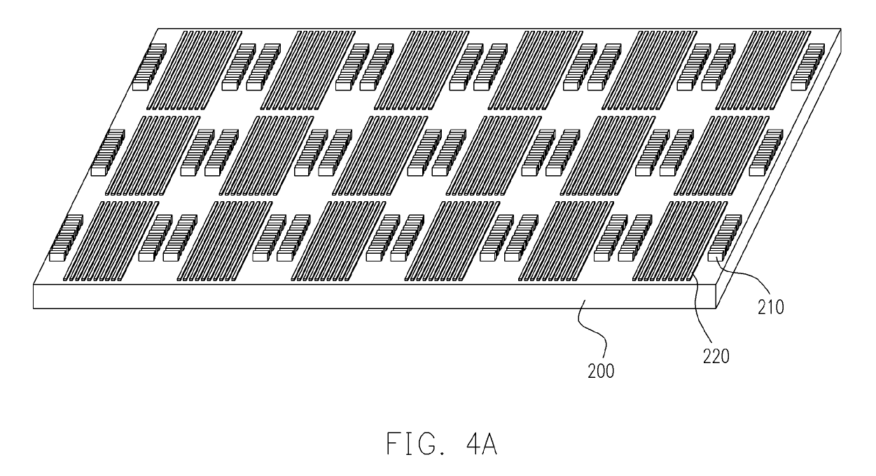

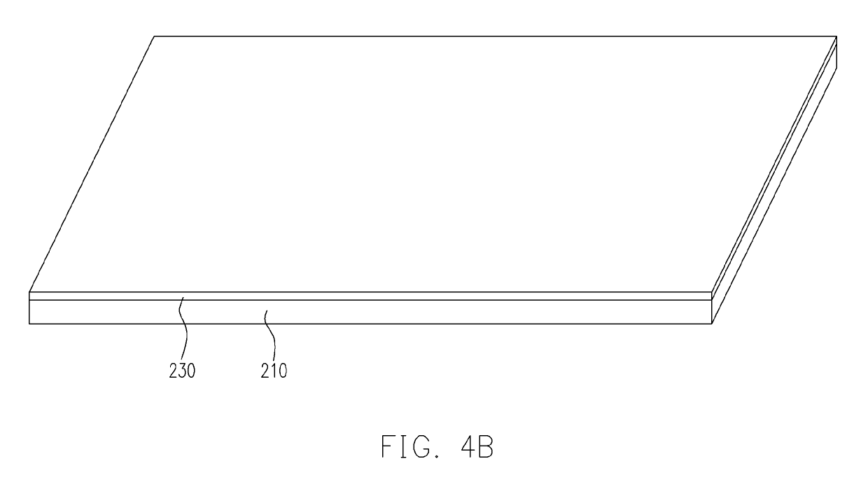

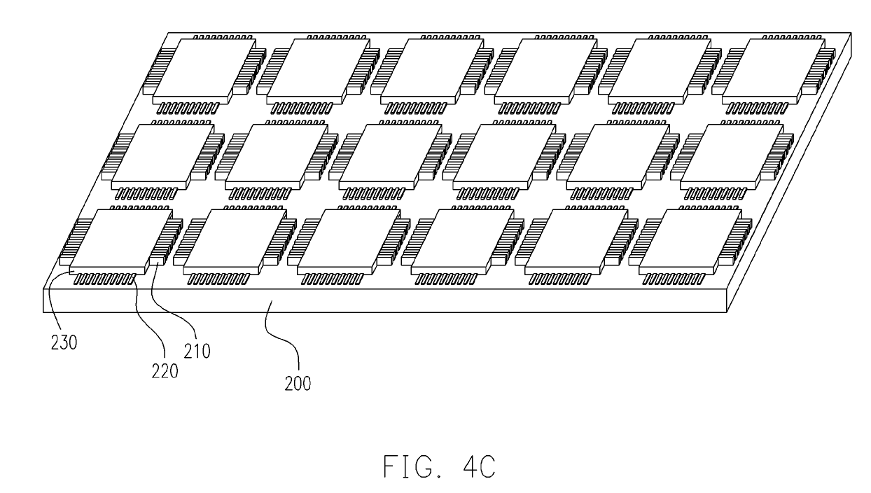

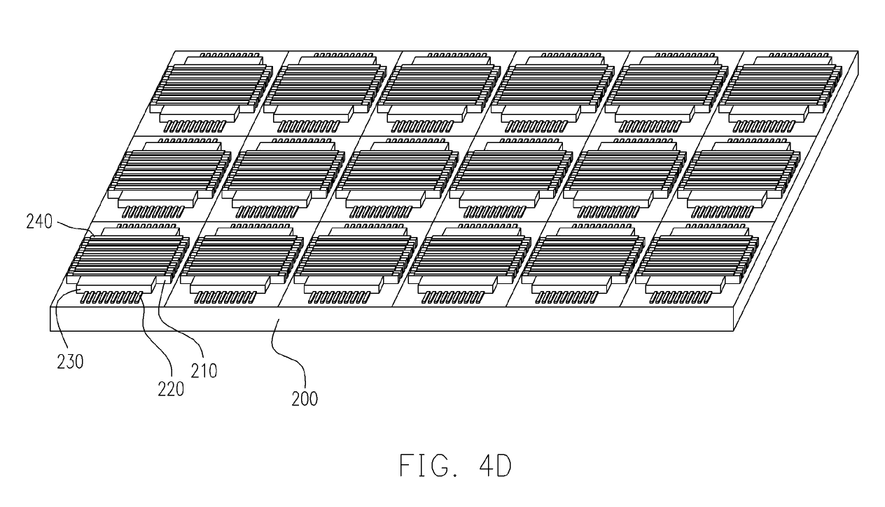

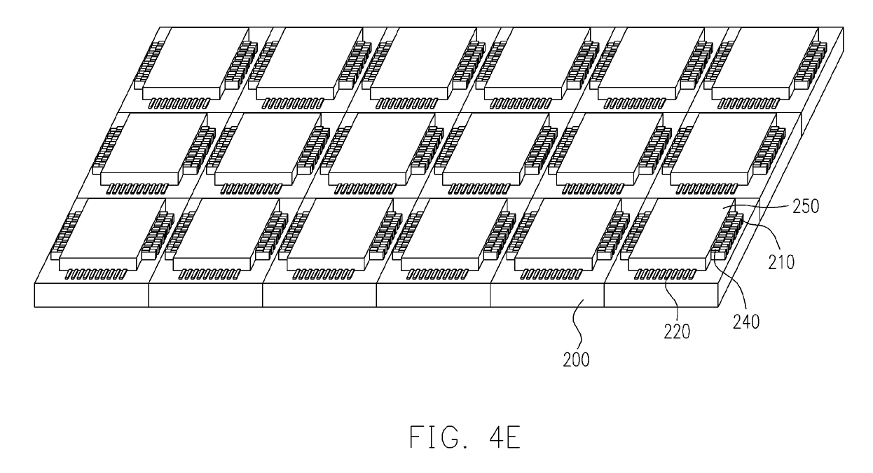

FIGS. 4A through 4E are perspective views showing the steps for fabricating an organic electro-luminescent device according to one preferred embodiment of the present invention. As shown in FIG. 4A, a substrate 200 fabricated from glass or other transparent material is provided. The substrate 200 also has a plurality of electrode leads 310 formed thereon. Thereafter, a first electrode layer 220 is formed over the substrate 200. The first electrode layer 220 and the electrode leads 210 are formed, for example, by sputtering indium tin oxide (ITO) over the substrate 200 and patterning the indium tin oxide layer.

As shown in FIG. 4B, an organic material layer 230 is formed over the first electrode layer 220 and a portion of the substrate 200. The organic material layer 230 is formed, for example, by performing a spin-on coating process or an evaporation process.

As shown in FIG. 4C, a portion of the organic material layer 230 is removed using an erasing liquid through wiping to form a patterned organic material layer 230. It should be noted that the process could be carried out in the non-vacuum environment.

As shown in FIG. 4D, a second electrode layer 240 is formed over the patterned organic material layer 230. The second electrode layer 240 is formed, for example, by sputtering or depositing a metallic layer (not shown) and patterning the metallic layer to form a plurality of parallel-aligned strips. Terminals of each second electrode layer 240 are electrically connected to the electrode leads 210.

As shown in FIG. 4E, molding compound is encapsulated over the organic material layer 230 to form a molding body 250 over a portion of the second electrode layer 240 and the organic material layer 230. The molding body 250 prevents the incursion of oxygen and water molecules into the device to cause a drop in reliability. Finally, the substrate 200 is cut up to form a plurality of organic electro-luminescent device.

In summary, the film removing equipment, the erasing device and the method of fabricating the organic electro-luminescent device according to the present invention has the following advantages.

1. Unlike a conventional dry etching process that requires the production of a new expensive mask for each new product, forming a new product with the film removing equipment only requires the reprogramming of the erasing device to follow a new pathway.

2. Through the transmission mechanism of the erasing device and the positioning platform, the film removing equipment can remove films from substrate with a range of sizes.

3. Since the erasing device on the film removing equipment removes films on a substrate through wiping, almost any type of film material can be removed. In particular, those materials that cannot be removed by a laser ablation process or a dry etching process can be removed using the film removing equipment.

4. Unlike the laser ablation process or the dry etching process that demands a high vacuum or a specific gaseous environment, the film removing equipment of the present is able to operate in the non-vacuum environment. Hence, overall equipment and maintenance cost is lower.

5. To increase the film removal rate and quality, an erasing liquid supply module can be incorporated with the erasing device to soak up the erasing tape so that films are remove through the abrasive action of the erasing liquid soaked erasing tape. Any dissolved film material is immediately carried away from the substrate by the erasing tape.

6. The erasing device deploys a tape supply/collect module and an erasing tape assembly. Hence, the erasing device of the present invention can operate continuously to complete a number of erasing processes without stopping the film removing equipment.

7. Unlike a laser ablation process or a dry etching process that can easily contaminate or damage the substrate, the method of fabricating the organic electro-luminescent device according to the present invention produces the least chemical contaminants and causes the least damage to the substrate. Moreover, the process of the present invention produces a stable and clean surface after the erasing operation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A film removing equipment for removing a film from a substrate, comprising:
a base;
a transmission mechanism set up on the base;
a first erasing device set up on the transmission mechanism; and
a positioning platform set up on the base for carrying the substrate, wherein the transmission mechanism drives the first erasing device to remove the film from the substrate.

2. The film removing equipment of claim 1, wherein the first erasing device comprises:
a tape supply module;
a tape collect module; and
a erasing head module set up between the tape supply module and the tape collect module, wherein tape supply module provides an erasing tape to the erasing head module and the tape collect module receives the used erasing tape from the erasing head module.

3. The film removing equipment of claim 2, wherein the tape supply module further comprises:
a tape supply mechanism for providing the erasing tape; and
a first set of idle wheels set up between the erasing head module and the tape supply mechanism.

4. The film removing equipment of claim 2, wherein the tape collect module further comprises:
a tape collect mechanism for receiving the erasing tape; and
a second set of idle wheels set up between the erasing head module and the tape collect mechanism.

5. The film removing equipment of claim 2, wherein the first erasing device further comprises an erasing head transmission mechanism for mounting the erasing head module.

6. The film removing equipment of claim 2, wherein the first erasing device further comprises an erasing liquid supply module connected to the erasing head module for providing some erasing liquid to the erasing head module.

7. The film removing equipment of claim 6, wherein the erasing head module further comprises an erasing liquid supply pass connected to the erasing liquid supply module for providing some erasing liquid to the erasing tape.

8. The film removing equipment of claim 2, wherein the firs erasing device further comprises at least an optical sensor set up somewhere along the transmission pathway of the erasing tape.

9. The film removing equipment of claim 2, wherein the erasing tape is fabricated using a dust-proofing cloth material.

10. The film removing equipment of claim 1, wherein the positioning platform further comprises a positioning mechanism for positioning the substrate on the positioning platform.

11. The film removing equipment of claim 1, wherein the equipment further comprises a positioning platform transmission mechanism connected to the positioning platform for controlling the movement of the positioning platform.

12. The film removing equipment of claim 1, wherein the equipment further comprises a second erasing device set up on the transmission mechanism of the erasing device.

13. An erasing device, comprising:
a tape supply module;
a tape collect module; and
an erasing head module set up between the tape supply module and the tape collect module, wherein the tape supply module provides an erasing tape to the erasing head module and the tape collect module receives the used erasing tape from the erasing head module.

14. The erasing device of claim 13, wherein the tape supply module further comprises:
a tape supply mechanism for providing the erasing tape; and
a first set of idle wheels set up between the erasing head module and the tape supply module.

15. The erasing device of claim 13, wherein the tape collect module further comprises:
a tape collect mechanism for receiving the erasing tape; and
a second set of idle wheels set up between the erasing head module and the tape collect module.

16. The erasing device of claim 13, wherein the erasing device further comprises an erasing head transmission mechanism for mounting the erasing head module.

17. The erasing device of claim 13, wherein the erasing device further comprises an erasing liquid supply module connected to the erasing head module for providing some erasing liquid to the erasing head module.

18. The erasing device of claim 17, wherein the erasing head module further comprises an erasing liquid supply pass connected to the erasing liquid supply module for providing some erasing liquid to the erasing tape.

19. The erasing device of claim 13, wherein the erasing device further comprises at least an optical sensor set up somewhere along the transmission pathway of the erasing tape.

20. The erasing device of claim 13, wherein the erasing tape is fabricated using a dust-proofing cloth material.
